(19) United States
(12) Patent Application Publication
(10) Pub. No.: US 2010/0006518 A1
(43) Pub. Date: Jan. 14, 2010

(54) QUICK INSTALLATION MOUNTING STRUCTURE

(76) Inventor: Thomas J. Brobst, Allentown, PA (US)

Correspondence Address: Nelson Mullins Riley & Scarborough LLP;IP Department, 100 North Tryon Street, 42nd Floor, Charlotte, NC, 28202-4000, US

(21) Appl. No.: 12/169,385

(22) Filed: Jul. 8, 2008

(51) Int. Cl. F16M 11/04; F16B 37/08

(52) U.S. Cl. 211/26; 411/432

(57) ABSTRACT

A quick installation mounting structure for use with a barcode scanning tunnel has at least one vertical post that defines a first plurality of axial slots formed along a length of the vertical post, at least one cross-member that defines a second plurality of axial slots formed along a length of the cross-member, at least one bracket for connecting the at least one vertical post to the at least one cross-member, and a plurality of fasteners. Each of the fasteners are received through the bracket so that an end of each fastener is received in one of the vertical post and cross member slots so that the fastener is rotationally fixed but axially moveable with respect to the vertical post or cross member.

### FIELD OF THE INVENTION

The present invention relates to system and methods for building a scanning tunnel and in particular to a conveyor tunnel frame fastener system and method.

### BACKGROUND OF THE INVENTION

Currently, it is labor intensive and time consuming to collect, assemble and install all the hardware (nuts, bolts, washers, etc.) and brackets necessary to erect a conveyor scanning tunnel at a customer location. Typically at least two technicians must set-up a scanning tunnel because it is difficult for one person to hold the frame members in place, align the connecting brackets and shimmy the bolts into place.

### SUMMARY OF THE INVENTION

The present invention recognizes and addresses considerations of prior art constructions and methods. In one embodiment of the present invention a quick installation mounting structure has at least one vertical post that defines a first plurality of axial slots formed along a length of the vertical post, at least one cross-member that defines a second plurality of axial slots formed along a length of the cross-member, at least one bracket for connecting the at least one vertical post to the at least one cross-member, and a plurality of fasteners, each of the fasteners comprising a cylindrical portion, an elongated shaped head coupled to the cylindrical portion, and a nut operatively received by the cylindrical portion. At least one of the plurality of fasteners is received through a respective one of the plurality of bracket holes so that the elongated shaped head can be received in a respective one of the plurality of vertical post axial slots. In this configuration, the respective nut can secure the vertical post to the bracket. Another fastener is received through another of the plurality of bracket holes so that the elongated shaped head is received in a respective one of the second plurality of cross member axial slots. In this configuration, a respective nut can secure the cross member to the bracket.

In another embodiment, the bracket has a base plate and two flanges that extend from the base plate. Thus, when the bracket is positioned adjacent the vertical post and cross member, one of the bracket flanges is positioned intermediate the post and cross member.

In yet another embodiment, the plurality of bracket holes further comprises at least one vertical extending slot and at least one horizontal extending slot.

In other embodiments, the vertical post first plurality of slots and the cross member second plurality of slots are each defined by respective spaced apart opposing flanges, where each set of spaced apart flanges form one side of a cavity that opens into the respective slot. Thus, in use, each of the plurality of fastener heads are received in a respective axial slot cavity so that the respective spaced apart opposing flanges rotationally fix the fastener cylindrical portion with respect to the axial slot.

In yet other embodiments, a plurality of vertical posts and a plurality of cross members are secured together with one or more brackets that together form the frame of the scanning tunnel. Thus, one or more of a barcode scanner and range finder can be coupled to one of the plurality of vertical posts or plurality of cross members.

The various embodiments of the invention can be assembled by a method comprising the step of providing (1) a vertical post defining at least one axial slot formed therein, (2) a cross-member defining at least one axial slot formed therein, wherein each of the at least one vertical post and the at least one cross member axial slots open into a respective cavity formed in the vertical post and the cross member, (3) at least one bracket for connecting the vertical post to the cross-member, the at least one bracket having a plurality of openings formed therethrough, and (4) a plurality of fasteners, each comprising a first end and an opposite second end. In another step, one of the plurality of fasteners is inserted through a first bracket opening so that the fastener first end is located on one side of the bracket and the fastener second end is located on an opposite side of the bracket. In another step, the fastener first end is inserted into the at least one vertical post slot cavity so that the fastener is rotationally fixed but axially slidable with respect to the vertical post. In yet another step, another one of the plurality of fasteners is inserted through a second bracket opening so that the fastener first end is located on the one side of the bracket and the another fastener second end is located on the opposite side of the bracket. In another step, the another fastener first end is inserted into the at least one cross member slot cavity so that the another fastener is rotationally fixed but axially slidable with respect to the cross member. In another step, the cross member is positioned with respect to the vertical post, and yet in another step the fasteners are tightened to secure the vertical post to the cross member by the at least one bracket.

In other embodiments of the method, the bracket further comprises a first and second flange extending from a base plate, wherein when the cross member is positioned with respect to the vertical post and the cross member, the first and the second bracket flanges are positioned intermediate the cross member and the vertical post. In other embodiments, the step of inserting the one fastener first end into the at least one vertical post slot cavity further comprises sliding the one fastener first end into the vertical post slot from one end of the vertical post so that the fastener head is rotationally fixed between two opposing flanges that define the slot. In yet other embodiments, the step of positioning further comprises sliding the one and the another fasteners in the respective slots so that the vertical post can be oriented with respect to the cross member.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a prior art conveyor driven scanning tunnel;

FIG. 2 is a partial perspective view of an embodiment of a quick installation mounting structure of the present invention;

FIG. 3 is an exploded view of the quick installation mounting structure of FIG. 2;

FIG. 4 is an exploded view of a bolt and locknut for use in the quick installation mounting structure of FIG. 2; and

FIG. 5 is a partial exploded view of the quick installation mounting structure shown in FIG. 2.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

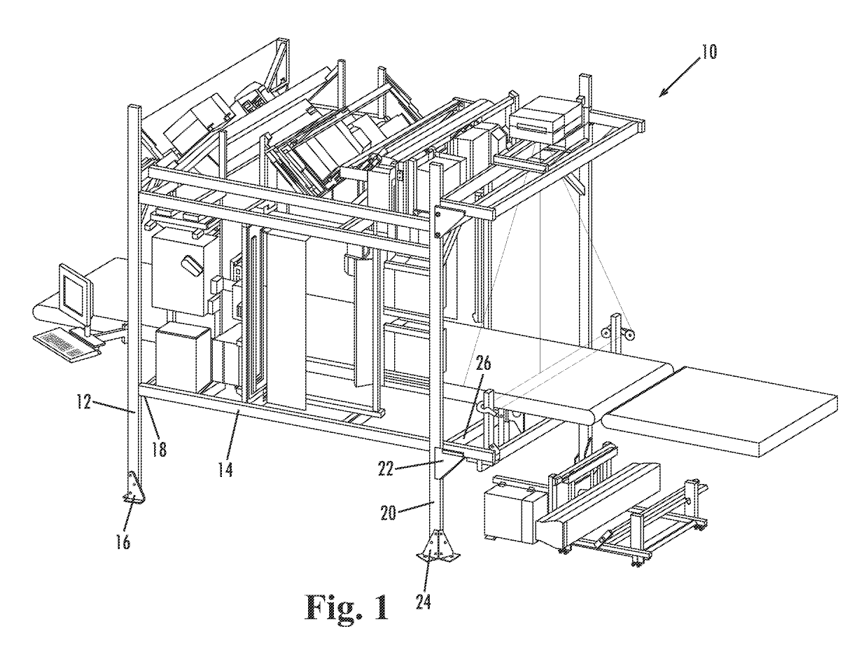

Referring to FIG. 1, a prior art conveyor scanning tunnel 10 is supported by a frame. The scanning tunnel has one or more of the following bar code readers (scanners and cameras), range finders, dimensioners, decoders, logic circuits, multiplexers, computers, monitors and keyboards, light curtains, power supplies, belt encoders, photo eyes, power distribution boxes, mirrors and wire troughs mounted on the frame of the tunnel using brackets. It should be understood that the term barcode reader refers to a generic reader such as a line scan reader, a camera reader, CCD reader or any other type of barcode reader. Dimensioning devices refers to the broad class of devices that include light curtains, photo eyes, dimensioners, range finders and other components for use in measuring the physical aspects of items that pass through the scanning tunnel.

Integral brackets 18 or separate brackets 22 connect cross members 14 and 26 to vertical posts 12. Posts 12 terminate in foot brackets 16 and 24, which allow scanning tunnel 10 to be mounted to a floor as well as providing the ability to level the scanning tunnel frame.

In prior art systems, posts 12 and cross members 14 and 26 were secured together using brackets 22 with standard fasteners, such as nuts and bolts. Posts 12 and cross members 14 and 26 were typically formed from a hollow, rectangular shaped metal member that contained bolt holes on opposing walls. Thus, when assembling the scanning tunnel, the cross member or post must be held securely to the bracket while the bolt is shimmied in place through the bolt holes. If the post bolt holes or the cross member bolt holes are not properly aligned, the bolt may not fit properly making it difficult for the technician to construct the scanning tunnel.

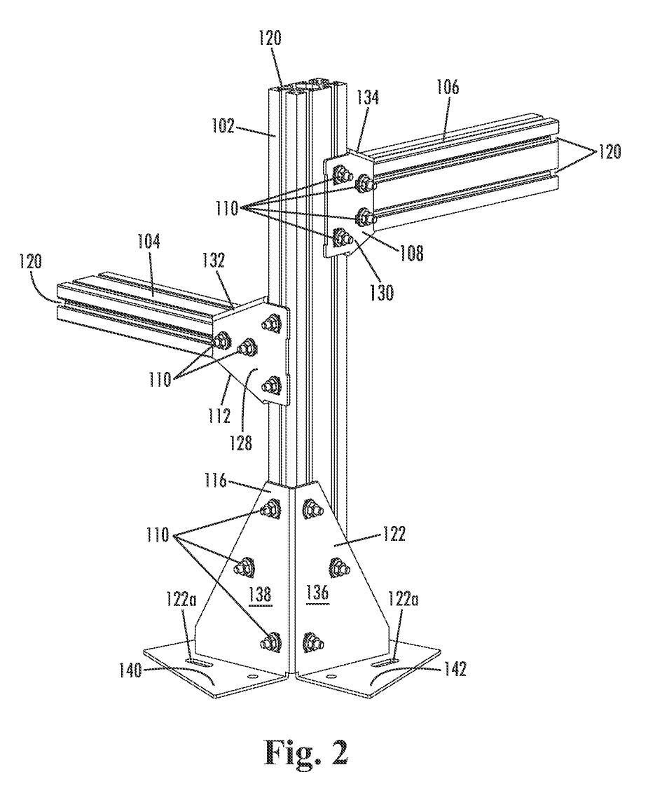

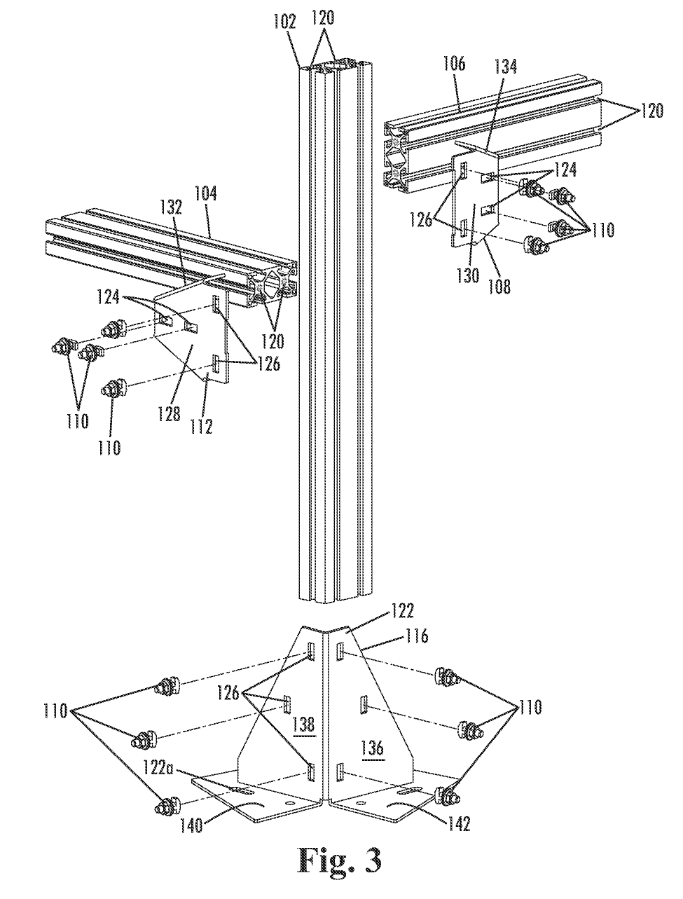

Referring to FIGS. 2 and 3, a new and improved quick installation mounting structure is shown. For ease of explanation, a single post 102 and two cross members 104 and 106 are shown with two brackets 108 and 112 and a single foot bracket 116, which connects to one end of post 102. It should be understood that the figure is not to scale and only a portion of each post and cross member is shown. Moreover, it should also be understood that a scanning tunnel of the present invention comprises one or more vertical posts and cross members like that shown in FIG. 1. In fact, the posts, cross members, brackets and fasteners of the present invention simply replace those shown in FIG. 1 to form a new and improved scanning tunnel that may be assembled by a single technician.

One or more axial slots 120 are formed in each post and cross member along the length of the post and cross member. A series of fasteners 110 are used to fasten the post and cross members together using brackets 108 and 112. In one embodiment, the fasteners are nuts and bolts but, in other embodiments, the fasteners may be other types of suitable fasteners. Foot bracket 122 is formed with at least one through-hole 122a to allow the vertical posts to be mounted to the floor. Referring to FIG. 3, the quick installation mounting structure of FIG. 2 is shown in an exploded view. Brackets 108 and 112 contain horizontal slots 124, which have a larger length than height, and vertical slots 126, which have a larger height than length. The horizontal and vertical slots are positioned so that the vertical posts and cross members can be secured in a predetermined position for the desired scanning tunnel configuration.

Brackets 108 and 112 are generally trapezoidal in shape with a flat base portion 128 and 130, respectively, in which the slots are formed, and two flanges 132 and 134, respectively, which are formed generally perpendicular to respective flat base portions 128 and 130. The width between flanges 132 and 134 is chosen to be slightly larger than a thickness of one dimension of the cross member being attached to vertical post 102. As shown in the figure, the minimum width between the opposing flanges of bracket 108 allows cross member 106 to be inserted in the bracket when the cross member is positioned with its sides parallel to the floor. Alternatively, the minimum width between the flanges of bracket 112 allows cross member 104 to be inserted in the bracket when the cross member is positioned with its top and bottom surfaces parallel to the floor. It should be understood that in addition to maintaining a cross member in relation to a vertical post during assembly, the bracket flanges provide strength and stability to the scanning tunnel since they are positioned intermediate the vertical post and cross member when used to secure one to the other. Therefore, the bracket not only secures to members but also provides structural support to prevent one member from rotating with respect to the second member through the bracket flanges.

Foot bracket 116 contains a plurality of vertical slots 126 that allow the foot bracket to be secured to the post. Foot bracket 116 is formed from two flat base portions 136 and 138 disposed perpendicular to one another, and two horizontal flanges 140 and 142 that are disposed perpendicular to a respective flat base portions 138 and 136. The shape and orientation of horizontal flanges 140 and 142 provide four general areas that allow the post to maintain an upright position once the post is secured to the foot. This assists the technician in assembling the scanning tunnel structure since it does not require another technician to hold the vertical post upright when first assembling the tunnel.

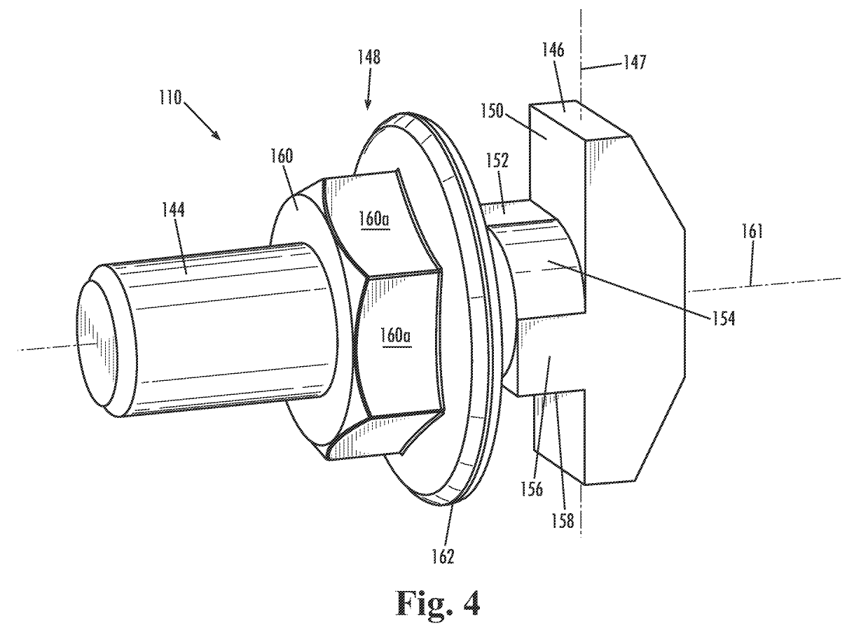

Referring to FIG. 4, fastener 110 is formed from a cylindrical body portion 144 defined about an axis 161. Cylindrical body portion 144 couples to a head 146 that extends radially outward from the cylindrical body portion. Head 146 defines a flat bottom surface 150 that couples to a shoulder 154, which is positioned intermediate the head and the cylindrical portion. Shoulder 154 has a first flat surface 152, a second flat surface 156 and a third flat surface 158. Head 146 is shaped to be front-loaded through one of horizontal slots 124 or vertical slots 126 in brackets 108 and 112 as well as in the slots formed in vertical post 102 and cross members 104 and 106, as further explained below.

Cylindrical body portion 144 receives a fastener 148, which in one embodiment contains a nut 160 and washer 162. Washer 162 may be integrally formed with nut 160 and contain locking serrations on a back surface. Threads (not shown) may be formed on an outer surface of cylindrical body portion 144 and an inner surface of nut 160 in order to secure fastener 148 to cylindrical body portion 144. Thus, as fastener 148 is rotated with respect to cylindrical body portion 144, the fastener is drawn down cylindrical body portion 144 toward head 146. Nut 160 may include a plurality of flat surfaces 160a to assist the user in rotating the nut by hand or with a tool such as a wrench.

In some embodiments, nut 160 and washer 162 may be preassembled so that the nut is located a predetermined distance from head 146. The predetermined distance ensures that the fastener is properly positioned in the vertical post or cross member slot when the nut is front-loaded through the bracket slots. In one embodiment, a thread locker, fast setting material rotationally fixes, in a releasable fashion, nut 160 at the predetermined location on the cylindrical body portion. Any locking material may be used to rotationally fix the nut at the predetermined location on the cylindrical body portion, such as resin, glue, etc. In any case, the releasable connection between the nut and the cylindrical body portion should be strong enough to allow the cylindrical portion to initially rotate with the nut over a limited distance until the fastener head properly seats in the vertical/cross member slot. Once the shoulder 154 rotates into position, shoulder flats 152, 156 and 158 prevent the cylindrical portion from further rotating allowing the nut to break loose from the cylindrical portion.

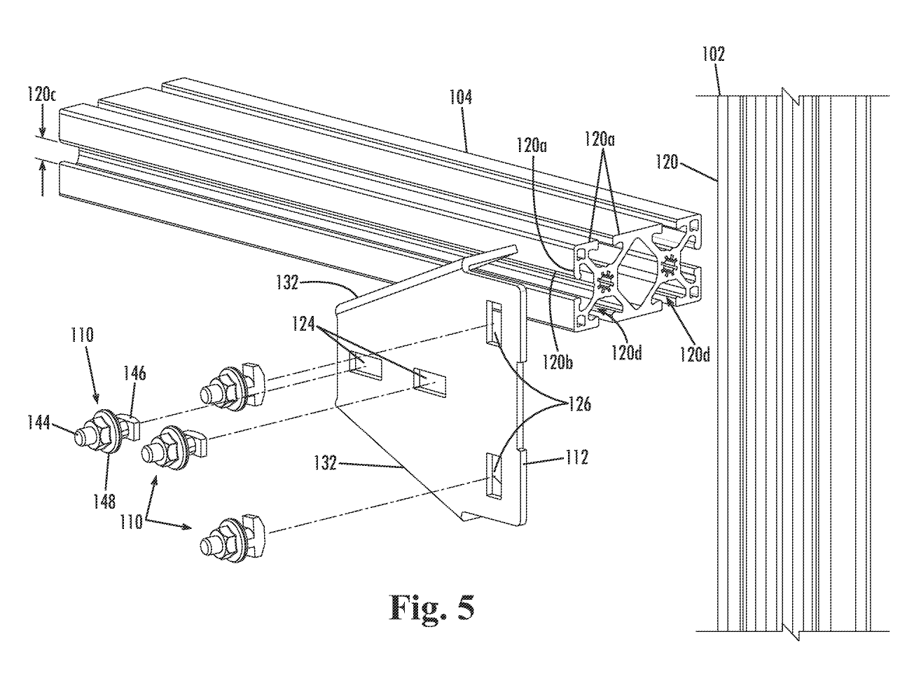

Referring to FIG. 5, illustrated is a detailed view of cross member 104, bracket 112 and vertical post 102. It should be understood that the construction of cross member 106 and vertical post 102 is generally the same in that each contains at least one axial slot 120 on each side. It should also be understood that while the basic construction of a cross member and a vertical post is similar, its length, width and height may differ, in addition to having differing bends formed therein, depending on its location within the scanning tunnel.

Two opposing flanges 120a together define slot 120. Each opposing flange 120a defines a wall 120b, where opposing walls are generally parallel to one another. A width 120c of slot 120 is configured to receive fastener shoulder 154 (FIG. 4). A cavity 120d, formed behind each slot 120 and bounded by flanges 120a, is shaped to receive fastener head 146. In one embodiment, cavity 120d is shaped substantially similar to fastener head 146. In other embodiments, cavity 120d is sized to receive the fastener head but does not necessarily have the same shape of the head. That is, while the head may be trapezoidal in shape, the slot cavity may be rectangular or square so long as the head of the fastener fits within the cavity.

In operation, and still referring to FIG. 5, the scanning tunnel is constructed by assembling cross members 104 to vertical posts 102 using bracket 112 and fasteners 110. In particular, bracket 112 is positioned on vertical post 102 at a predetermined location. Next, preassembled fasteners 110 are front loaded by passing fastener heads 146 through bracket slots 126 and vertical post slot 120. Once positioned, nut 160 is rotated causing cylindrical body portion 144 and head 146 to rotate simultaneously with nut 160 until one or more of shoulder flat portions 152, 156 and 158 are aligned with slot walls 120b. Once in this position, the slot flanges prevent cylindrical body portion 144 from rotating so that nut 160 breaks loose from cylindrical body portion 144 and begins to rotate with respect to the cylindrical body portion. A second fastener, placed in the other vertical bracket slot, aids in securing the bracket to the vertical post. Prior to tightening the nuts, the user may slide the bracket along the post length into place and then tighten the nuts to secure the bracket in place. Once nut 160 is further rotated, bracket flat base portion 128 is drawn against the outer face surface of flanges 120a, thereby securing the bracket to the cross member. The same procedure may be carried out on another vertical post using a second bracket. It should be understood that in other embodiments, the fasteners may be placed into the bracket vertical slots and then slid into post cavity 120d from one end of the post. This allows the user to position the bracket on the post by axially sliding the bracket along the length of the post.

Next, a cross member is placed into two opposing brackets so that the cross member fits between the bracket flanges. Because the bracket flanges are spaced apart to closely fit the cross-member, the bracket flanges will hold the cross member in place, thereby freeing up both hands of the user. Thus, the user is free to insert additional fasteners into bracket horizontal slots 124 prior to securing each of the fasteners in place. This configuration allows a single technician to assemble the tunnel structural parts since the brackets alone can self-support the cross member, thereby allowing the user to insert additional fasteners to secure the cross member in place.

A variety of brackets may be used to meet the various needs of the tunnel structure. For example, brackets may include tabs (not shown) that allow the bracket to be temporarily secured to a cross member when attached to large components. In this way, the user can locate the component in the scanning tunnel and allow the bracket tab to temporarily secure the bracket to the cross member while the user front-loads fasteners through the bracket slots into the cross member slots. Other brackets may also include tabs formed with a lip so that the tab can be placed over a side of the cross-member so that the lip retains the brackets in place. These types of brackets are useful when heavy equipment is attached to the scanning tunnel. It should be understood that various bracket configurations are contemplated within the scope of the present invention each being configured to allow a single technician to assemble the scanning tunnel of the present invention. Most, if not all brackets, will include flanges disposed at an angle with respect to the base plate

Attachment of foot bracket 116 to vertical post 102 is similar to that described above with respect to bracket 112. With regard to foot bracket 116 and referring to FIG. 3, one foot bracket side 138 would receive two fasteners whose heads would be received in a common slot, while the other side 136 would receive three fasteners, one in one slot 120 and the other two in an adjacent slot formed on a common side of vertical post 102. The shape an orientation of foot bracket 116 allows a vertical post to free-stand without the assistance of the user. Therefore, once attached to a vertical post, the user can space-apart several vertical posts so that the brackets are positioned to accept a cross member.

The present invention provides an easy to assemble scanning tunnel structure since the fastener may be preassembled where the nut is both axially and rotationally moveable with respect to the fastener cylindrical portion. In some embodiments, the fastener nut may be fixed on the fastener cylindrical portion so that it cannot move axially off the end of the cylindrical portion opposite the fastener head. In this configuration, the fastener is essentially a one piece fastener that can be adjusted over a range so that the technician does not have to search for a fastener bolt and nut, and then take the time to connect one to the other. In other embodiments, the vertical posts and cross-members may have one or more axial slots formed on each side. Yet in other embodiments, brackets 108 and 112 may be formed without flanges 132 and 134. In additional embodiments, fasteners 110 may come permanently affixed to brackets 108 or 110 so that the technician can attach a bracket to a post or cross-member without the fasteners breaking free from the bracket. This configuration provides an easy to assemble structure while minimizing the number of loose parts that can inadvertently be misplaced. In yet other embodiments, brackets 108 and 112 may be preassembled to vertical posts so that the user does not need to determine where along the vertical post the bracket must be set. Thus, during assembly of the tunnel structure, the user only has to secure cross members between the vertical posts to fully assemble the tunnel structure.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. A quick installation mounting structure for use with a barcode scanning tunnel comprising:
a. a vertical post defining a plurality of axial slot formed along a length of said vertical post;
b. a cross-member defining a plurality of axial slot formed along a length of said cross-member, wherein each of said plurality of vertical post slot and said cross member slot open into a respective cavity formed therein,
c. a bracket for connecting said vertical post to said cross-member, said bracket having
i. a base plate,
ii. a plurality of slots formed in said base plate, and
iii. first and second flanges that extend at an angle from said base plate,
wherein said first and second flanges are spaced apart a predetermined distance that is slightly larger than one of said cross-member height and width,
d. a plurality of fasteners having a first end and an opposite second end;
wherein
one of said plurality of fasteners is received through a respective one of said plurality of bracket slots so that said first end of said fastener is positioned on one side of said bracket base and said second end of said fastener is positioned on an opposite side of said bracket base, and
when said bracket is positioned adjacent to said vertical post and said cross member, said bracket base plate abuts said vertical post and said cross member and said first and said second bracket flanges are positioned intermediate said vertical post and said cross member.

2. The quick installation mounting structure of claim 1, said plurality of fasteners comprising,
i. a cylindrical portion,
ii. an elongated shaped head coupled to said cylindrical portion, and
iii. a nut operatively received by said cylindrical portion;
wherein
when at least one of said plurality of fasteners is received through a respective one of said plurality of bracket slots, said elongated shaped head can be front-loaded into a respective one of said plurality of vertical post axial slots so that said respective nut can secure said bracket to said vertical post, and
when another one of said plurality of fasteners is received through another of said plurality of bracket slots, said another elongated shaped head can be front-loaded into a respective one of said second plurality of cross member axial slots so that said respective nut can secure said cross member to said bracket.

3. The quick installation mounting structure according to claim 1, wherein said plurality of bracket slots further comprise at least one vertical extending slot and at least one horizontal extending slot.

4. The quick installation mounting structure according to claim 2, wherein said bracket first flange and said bracket second flange are disposed on said bracket base plate at an angle with respect to one another.

5. The quick installation mounting structure according to claim 1, wherein said bracket is positioned intermediate said one fastener nut and a pair of spaced apart opposing flanges that define said one of said vertical post axial slots.

6. The quick installation mounting structure according to claim 1, wherein said vertical post first plurality of axial slots and said cross member second plurality of axial slots are each defined by respective spaced apart opposing flanges, where each set of spaced apart opposing flanges together bound a cavity that opens into said respective slot.

7. The quick installation mounting structure according to claim 6, wherein each of said plurality of fastener heads are received in a respective axial slot cavity so that said respective spaced apart opposing flanges rotationally fix said fastener cylindrical portion with respect to said axial slot.

8. The quick installation mounting structure according to claim 1, further comprising a plurality of vertical posts, a plurality of cross members and a plurality of brackets that together form the frame of the scanning tunnel.

9. The quick installation mounting structure according to claim 8, further comprising at least one of a barcode reader, a dimensioning device and electrical components coupled to one of said plurality of vertical posts and said plurality of cross-members by respective brackets.

10. The quick installation mounting structure according to claim 1, wherein said bracket first and second flanges prevent said vertical post and said cross member from substantially rotating with respect to each other.

11. The quick installation mounting structure according to claim 1, further comprising a foot bracket having
a. a first base plate mounted at approximately a ninety degree angle with respect to a second base plate, and
b. a first flange coupled to said first base plate and a second flange coupled to said second base plate,
wherein each of said first and said second base plates has at least one slot formed therethrough for mounting said foot bracket to said vertical post.

12. The quick installation mounting structure according to claim 11, wherein at least one of said plurality of fasteners releasably couples said vertical post to said foot bracket.

13. A method for building a barcode scanning tunnel using a quick installation mounting structure, said method comprising:
a. providing
i. a vertical post defining at least one axial slot formed therein;
ii. a cross-member defining at least one axial slot formed therein;
wherein each of said at least one vertical post and said at least one cross member axial slots open into a respective cavity formed in said vertical post and said cross member,
iii. at least one bracket for connecting said vertical post to said cross-member, said at least one bracket having
a base plate defining a plurality of slots therethrough,
a first flange disposed at an angle with respect to said base plate, and
a second flange disposed at an angle with respect to said base plate,
iv. a plurality of fasteners, each comprising a first end and a shaped second end;
b. placing a first portion of said bracket adjacent said vertical post;
c. attaching said bracket first portion to said vertical post using one of said plurality fasteners;
d. placing said cross member against said bracket base plate intermediate said first and said second flanges;
e. attaching said bracket base plate to said cross member using another one of said plurality of fasteners.

14. The method for building a barcode scanning tunnel of claim 13, wherein said fastener further comprises a nut positioned proximate said fastener first end.

15. The method for building a barcode scanning tunnel of claim 13, wherein the step of attaching said bracket to said vertical post further comprises:
a. inserting one of said plurality of fasteners through a first bracket slot so that said fastener shaped first end is located in said at least one vertical post slot and said nut is located on an opposite side of said bracket base plate; and
b. rotating said nut with respect to said vertical member so that said fastener shaped head rotates in said vertical post slot over a limited distance at which time said nut rotates with respect to said fastener first end.

16. The method for building a barcode scanning tunnel of claim 13, wherein at least one of said bracket first and second flanges is positioned intermediate said vertical post and said cross-member.

17. The method for building a barcode scanning tunnel of claim 15, wherein the step of inserting said one fastener shaped second end into said at least one vertical post slot further comprises sliding said one fastener shaped second end into said vertical post slot cavity from one end of said vertical post so that said fastener shaped second end is rotationally fixed between two opposing flanges defining said slot.

18. The method for building a barcode scanning tunnel of claim 13, further comprising attaching one of a barcode reader and dimensioning device to said cross member using another one of said plurality of fasteners.

19. The method for building a barcode scanning tunnel of claim 13, wherein
a. said fastener comprises a nut releasably fixed at said fastener first end at a predetermined distance from said fastener shaped second end, and
b. said nut is rotationally coupled to said fastener first end until said fastener shaped second end becomes rotationally fixed to said vertical post.

20. A method for building a barcode scanning tunnel using a quick installation mounting structure, said method comprising:
a. providing
i. a plurality of vertical posts each defining at least one axial slot formed therein;
ii. a cross-member defining at least one axial slot formed therein;
wherein each of said plurality of vertical posts and said cross member axial slots open into a respective cavity formed in each of said plurality of vertical posts and said cross member,
iii. a plurality of brackets for connecting said plurality of vertical posts to said cross-member, said plurality of brackets each having
a base plate defining a plurality of slots therethrough,
a first flange disposed at an angle with respect to said base plate, and
a second flange disposed at an angle with respect to said base plate,
wherein said bracket first flange and said bracket second flange define an open channel therebetween,
iv. a plurality of fasteners, each comprising a first end and a shaped second end;
b. placing a first portion of one of said plurality of brackets adjacent said vertical post;
c. attaching said first portion of one of said plurality of brackets to said vertical post using one of said plurality fasteners;
d. placing said cross member against said bracket base plate in said bracket open channel;
e. attaching said bracket base plate to said cross member using another one of said plurality of fasteners.

21. The method for building a barcode scanning tunnel of claim 20, wherein said fastener further comprises a nut releasably positioned proximate said fastener first end a predetermined distance from said fastener shaped second end.

22. The method for building a barcode scanning tunnel of claim 21, wherein the step of attaching said first portion of one of said plurality of brackets to said vertical post further comprises:
a. inserting one of said plurality of fasteners through a first bracket slot so that said fastener shaped first end is located in said one of said plurality of vertical post slots so that said nut is located on an opposite side of said bracket base plate from said one of said plurality of vertical posts; and
b. rotating said nut with respect to said one of said plurality of vertical posts so that said fastener shaped head rotates in said one of said plurality of vertical posts slots over a limited distance at which time said nut begins to rotate with respect to said fastener first end.
